(19) United States
(12) Patent Application Publication
(10) Pub. No.: US 2003/0233575 A1
(43) Pub. Date: Dec. 18, 2003

(54) Method of analysing level of information security in an organization

(76) Inventors: Kimmo Syrjanen, Espoo (FI); Tuija Kohonen, Helsinki (FI)

Correspondence Address: PILLSBURY WINTHROP, LLP, P.O. BOX 10500, MCLEAN, VA, 22102, US

(21) Appl. No.: 10/166,733

(22) Filed: Jun. 12, 2002

(51) Int. Cl. G06F 11/30

(52) U.S. Cl. 713/201

(57) ABSTRACT

A method of analysing level of information security of an organization by means of a first and a second reference group of people, the first reference group comprising personnel, who are implementing strategic decisions of the organization, and the second reference group comprising personnel, who are participating in strategic decision-making. Actual level of information security is analysed on the basis of quantitative measures obtained from the first reference group. The second reference group gives measures for analysing assumed level of information security and/or for defining target level of information security. How well a target has been reached is analysed after a certain time period in an information security audit, wherein the actual level of information security is again found out. The steps of setting target and auditing the results can be repeated in order to create continuous development cycle of information security on the basis of organization's own needs.

### FIELD OF THE INVENTION

The present invention relates to information security and, more particularly, to a method of analysing level of information security in an organization.

### BACKGROUND OF THE INVENTION

Information security deals with securing important data, business plans and other confidential information of organizations, so that they are protected from theft or unauthorized disclosure. As the use of Internet and other information networks has increased, vulnerability of proprietary systems has increased. In order to tackle information security threats, various technical and non-technical measures and best practices have been developed. For example, internal networks of organizations are protected by firewalls and virus scanners, network traffic is monitored by means of Intrusion Detection Systems (IDS), and information security policies telling how organizations' information systems should be used, are defined. Nevertheless, only existence of these systems does not make organisations' information systems secure. The level of information security depends largely on how these systems are used organization-wide and the weakest link in the system determines security of the whole system.

Information security standards and methods offer a good basis for developing information security, but they only tell what should be done in general and do not provide assessment of the current level of information security or classification of, what has already been done adequately and on what areas additional actions are required.

Therefore, in order to find out which are the areas where information security of an organization should be improved, the level of information security should be somehow assessed. Since information security is not dependent solely on information security administration, but the whole organizations affects information security, this task is not trivial. An information security consultant, who has interviewed information system administration and other personnel, has traditionally made such assessments on the basis of previously recognized best practices and information security standards.

Used measurement methods commonly concentrate on information security strategy instead of giving practical guidance for improving information security. In addition, information security assessment made by a consultant is often qualitative assessment and the results are hardly comparable with results of another consultant.

Therefore a new solution is needed for analysing information security in order to produce comparable results.

### SUMMARY OF THE INVENTION

An object of the invention is to provide a new method, computer program product and system for analysing level of information security in an organization.

This object of the invention is achieved according to the invention as disclosed in the attached independent claims. Preferred embodiments of the invention are disclosed in the dependent claims. The features described in one dependent claim may be further combined with features described in another dependent claim to produce further embodiments of the invention.

The idea of the invention is to define quantitative measures for assessing level of information security. Where suitable, the quantitative measures can be further verified and adjusted by means of qualitative assessment.

According to the invention, information security level of an organization is analysed on the basis of different reference groups. A first reference group comprising personnel, who are implementing strategic decisions of the organization, is used for defining actual level of information security and a second reference group comprising personnel, who are participating in strategic decision-making, is used for defining assumed level of information security on one hand and target level of information security on the other hand.

According to one aspect of the invention current level of information security is first found out, and then on the basis of the current level, target level for information security is defined. The current level of information security comprises at least actual level of information security, which is analysed by means of the first reference group, and possibly also assumed level of information security, which is analysed by means of the second reference group. After certain time period, the actual level of information security is again found out and compared to the target level in order to find out, if the target has been reached. After this a new target can be defined in order to create continuous development cycle on the basis of organization's needs. In this way, organization's own needs are taken into account in the assessment and the organizations can flexibly adjust its target level of security when needed.

The method of the invention comprises according to one aspect the steps of

defining a first and a second reference group of people within the organization, the first reference group comprising personnel, who are implementing strategic decisions of the organization, and the second reference group comprising personnel, who are participating in strategic decision-making,

presenting to members of said first reference group a plurality of first statements regarding information security of the organization, said first statements being classified into a plurality of categories,

collecting from the members of said first reference group numerical values for the first statements,

calculating characterising values for said categories on the basis of numerical values given to the first statements of respective categories, said characterising values indicating actual level of information security for said respective categories,

presenting to members of said second reference group said plurality of first statements regarding information security of the organization,

collecting from the members of said second reference group numerical values for the first statements,

calculating second characterising values for said categories on the basis of numerical values given by the second reference group to the first statements of respective categories, said second characterising values indicating assumed level of information security for said respective categories, and

outputting for the plurality of categories respective actual and assumed levels of information security.

That is, in this option, the second reference group gives values for the same statements that are presented to the first reference group and tries to give for the statements the values they assume that the first reference group gives or should give.

According to another aspect the invention comprises

defining a first and a second reference group of people within the organization, the first reference group comprising personnel, who are implementing strategic decisions of the organization, and the second reference group comprising personnel, who are participating in strategic decision-making,

presenting to members of said first reference group a plurality of first statements regarding information security of the organization, said first statements being classified into a plurality of categories,

collecting from the members of said first reference group numerical values for the first statements,

calculating characterising values for said categories on the basis of numerical values given to the first statements of respective categories, said characterising values indicating actual level of information security for said respective categories,

presenting to members of said second reference group second statements regarding information security of the organization in said plurality of categories,

collecting from the members of said second reference group numerical values for the second statements, said numerical values indicating assumed level of information security for said categories, and

outputting for the plurality of categories respective actual and assumed levels of information security.

That is, in this option, the second reference group gives preferably only one value for each category, the value giving their assumption of the level of information security of the organization in respective category. Like above, the second reference group expresses its assumption of the level of information security, but now the different aspects are not specified on as fine-grained level as above.

According to still other aspect the invention comprises

defining a first and a second reference group of people within the organization, the first reference group comprising personnel, who are implementing strategic decisions of the organization, and the second reference group comprising personnel, who are participating in strategic decision-making,

presenting to members of said first reference group a plurality of first statements regarding information security of the organization, said first statements being classified into a plurality of categories,

collecting from the members of said first reference group numerical values for the first statements,

calculating characterising values for said categories on the basis of numerical values given to the first statements of respective categories, said characterising values indicating actual level of information security for said respective categories,

collecting from the second reference group numerical target levels of information security for said plurality of categories,

comparing for a category the target level and actual level of information security, and if the actual level is different from the target level, outputting at least one action point for reaching the target level for said category.

Now, the assumed level of information security is not analysed, but the analysis concentrates on helping in development of information security. The second reference group states target values for different categories on the basis of analysed actual level of information security. By first analysing the actual level of information security, it is possible to define realistic target values and additionally to focus resources on areas where there are most severe defects in information security.

As mentioned above, target level of information security may be defined on the basis of analysed actual level of information security in order to develop information security of a given organization. Analysis of assumed level of information security is not needed for defining target level, but also assumed level may be used in defining the target. For this purpose, numerical target levels of information security for different categories are collected from the second reference group.

In order to find out how to reach the target, the target levels and actual levels are compared for each category. If the levels are different, at least one action point for reaching the target level for said category is output. The action points are based on previously identified and tested best practices and relate to verbal counterpart of the value given as a target. Additionally the action point depends on the actual level of information security.

For finding out if the target has been reached or not, an information security audit is set up. This means that the analysis of actual level of information security by means of the first reference group is repeated after a suitable period of time has lapsed since the last analysis.

The target levels and new actual levels of information security can then be compared. The (possible) differences between them can be classified into critical and less critical differences, a critical difference indicating that the actual level of information security is substantially lower than the target. Less critical differences may be further classified into moderate or low defects. By means of this kind of analysis, the areas where development of information security has failed and immediate actions are needed are clearly identifiable.

Above described information security audits are preferably repeated regularly in order to follow development of information security and to guide the development to the right direction on the basis of most recent information. In this way also possible defects in information security are identified as soon as possible. Additionally, since the organization itself defines the target levels for different categories, the development of information security and weighting of different aspects of information security are completely configurable for the needs of a given organization. Moreover, changing operating environments and requirements can be taken into account by adjusting the target levels when needed.

The invention further provides possibility to use either internal or external benchmarking for comparing an organization to other (possibly substantially similar) organizations or for comparing a unit of a given organization to different units of the organization. Since the level of information security can be stored in numerical format, it is straightforward to store results of analyses for future purposes. For example a block chart can then be generated for visualising differences between information security levels of different units of an organization or information security level of a given organization versus industry average.

The quantitative analysis of the invention may be further affirmed by means of qualitative interview analysis, which is made by a consultant, and wherein further meaning of various answers can be discussed. The results of this qualitative analysis can be attached to the quantitative analysis for example in form of a third reference group. Alternatively, the qualitative analysis may be used for adjusting the values given to different statements, whereby the overall result of the analysis is adjusted.

### BRIEF DESCRIPTION OF THE DRAWINGS

Various features of the invention, as well as the advantages offered thereby, are described hereinafter in more detail with reference to embodiments illustrated in the accompanying drawings, in which

FIG. 1 illustrates a general overview of the invention,

FIG. 2 is a flow chart illustrating one aspect of the invention,

FIG. 3 is a flow chart illustrating another aspect of the invention, and

FIG. 4 is a flow chart illustrating still another aspect of the invention.

### PREFERRED EMBODIMENTS OF THE INVENTION

The method of the invention is based on nine assumptions:

Information security as a concept comprises universal processes, methods and technologies, which offer the best possible information security for an organization, when used in all activities of the organization.

Only previously known information security threats can be avoided by means of economical processes, methods and technologies.

Absolute security of information is purely theoretical concept.

Identifying previously unknown threats and developing defense for them is not economical for an organization, whose core business is not development of information security.

The best possible information security can be reached by using the concrete processes, methods and technologies, which have been developed for avoiding previously known information security threats.

The best possible processes, methods and technologies have been tested in practice and found to work as expected.

Only the organization, whose information security is in question, can define, what is adequate level of security.

Security offered by any process, method or technology exists only until someone figures out a way to circumvent the process, method or technology.

All methods and processes require continuous and immediate updating.

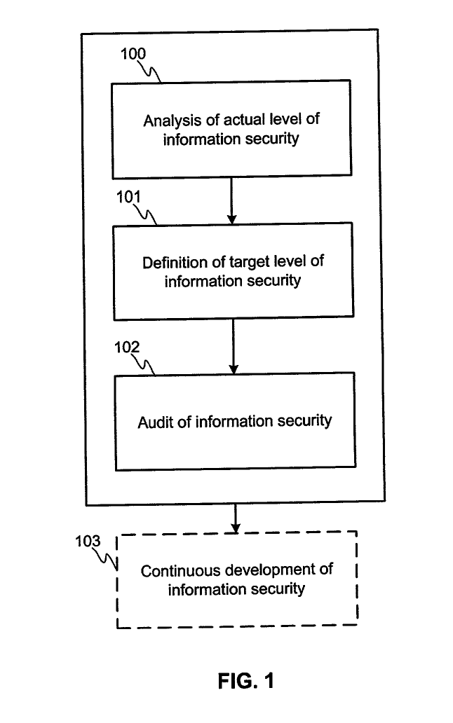

FIG. 1 illustrates a general overview of the invention. In block 100 actual level of information security is first analysed. Analysis of actual level of information security may include analysis of assumed level of information security, assumed level being assumption of top management and other strategic decision-making personnel. Then, in block 101, target level of information security is defined. This is done by the decision-making personnel on the basis of the analysis of actual and possibly also assumed level of information security. Setting the target may be done interactively with help of a consultant. In any case previously analysed actual (or current) level of information security enables setting a realistic target. How well the target has been reached is analysed after a certain time period in block 103, wherein the analysis of actual level of information security is repeated in an information security audit. The results of the audit can then be analysed in the light of the target levels and used as a basis for setting new targets, which are again audited and so on. These three steps result in continuous development of information security illustrated in block 104.

According to the invention, information security level of an organization is analysed on the basis of different reference groups. A first reference group comprising personnel, who are implementing strategic decisions of the organization, is used for defining actual level of information security and a second reference group comprising personnel, who are participating in strategic decision-making, is used for defining assumed level of information security on one hand and target level of information security on the other hand. Personnel belonging to the first reference group are for example information system administration, middle management and specialists, general personnel, and/or production personnel, and personnel belonging to the second reference group are for example top management and owners of processes, such as information system manager, security manager, administrative manager, financial manager, and personnel manager.

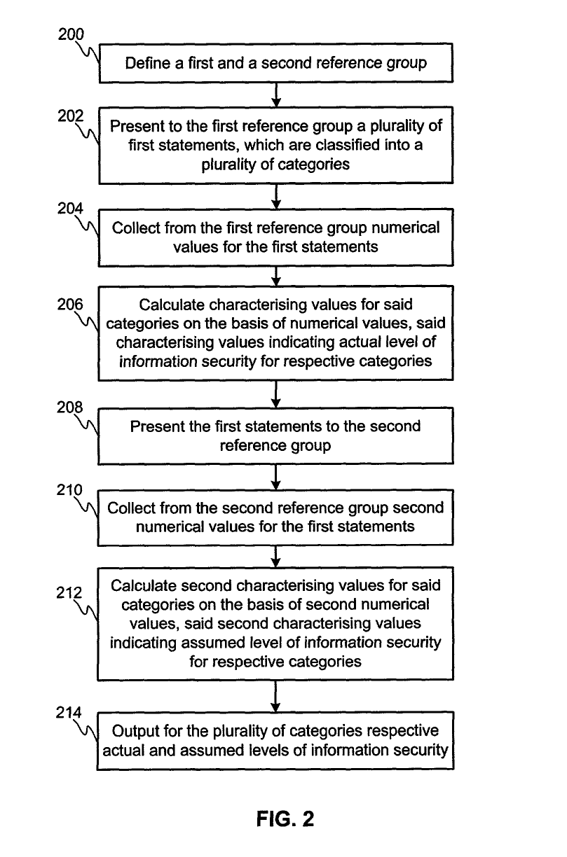

FIG. 2 is a flow chart illustrating one aspect of the invention. In step 200 a first and a second reference group of people within the organization are defined. As discussed above, the first reference group comprises personnel, who are implementing strategic decisions of the organization, and the second reference group comprises personnel, who are participating in strategic decision-making. In step 202, a plurality of first statements, which concern information security of the organization and are classified into a plurality of categories, are presented to members of said first reference group, and in step 204 numerical values for these first statements are collected from the members of said first reference group. Then in step 206, characterising values are calculated for said categories on the basis of numerical values given to the first statements of respective categories, said characterising values indicating actual level of information security for said respective categories. The characterising values can be obtained from the values given to associated statements for example by calculating mean, weighted mean or standard deviation of said numerical values. Also some other statistical formula can be used.

In step 208 and 210, the first statements are presented to members of the second reference group, and second numerical values for these first statements are collected from the members of said second reference group. And in step 212, second characterising values are calculated for said categories on the basis of second numerical values given to the first statements of respective categories, said characterising values indicating assumed level of information security for said respective categories. Below, all characterising values are calculated similarly.

As a result, respective actual and assumed levels of information security are output for the plurality of categories in step 214.

That is, in this option, the second reference group gives values for the same statements that are presented to the first reference group and tries to give for the statements the values they assume that the first reference group gives or should give.

The numerical values given to different statements are naturally not just any values, but they do have a certain range and each value has a verbal counterpart indicating what the value actually means. In the following table a possible range of values and meaning of different values is presented.

| Value | Verbal meaning |
|---|---|
| 0 | The target is not taken into consideration (it has been decided that |
| | there is no need) |
| 1 | The target has not been considered |
| 2 | The target has been considered but not developed |
| 3 | The target is under development |
| 4 | Information security controls and processes have been developed |
| | for the target |
| 5 | Information security controls and processes are continuously devel- |
| | oped and traced for the target |

The categories for which the level of information security is analyzed are for example data security, administrative and organizational information security, personnel security, physical security, telecommunication security, software security, facilities security, operations security, contingency planning, and compliance with requirements. These categories may be further divided into subcategories. For example telecommunication security may be divided into subcategories of network topology, firewall, Internet, WAN, remote connections, WLAN, email, virus scanning, and IDS. Similarly, administrative and organizational information security may be further divided into information security strategy, information security policy, information security guidelines and risk management.

A category or a subcategory may be additionally divided into technological aspects, procedural aspects, and administrative aspects, in order to further specify the results of the analysis. The output of the analysis may be given on the level of subcategories, that is by means of mean value of values given to statements belonging to a subcategory, or on the level of upper level categories, that is for example by means of a characterizing values calculated for the subcategories. Additionally, an overall value for organization's information security may be calculated by taking mean value of values calculated for the upper level categories. The most accurate results are clearly obtained on the subcategory level, whereby the aspect of information security, to which a given value refers, is specified in most detail.

Especially in the first reference group, people are divided into different subcategories depending on their duties, and at least partially different first statements are selectively presented to them so that only statements, which are related to their duties, are presented to them. That is, people need to answer only to those questions to which they should have an answer. (There may be a possibility to answer “I don't know”, but minimizing the amount of “I don't know” answers gives better and more accurate results.) If we consider for example a subcategory of remote connections, following statements may be presented to different groups of personnel:

Remote connections can be taken only to a predefined set of network services. Information system administration

Remote connections are secured and use string authentication. Information system administration

There are guidelines for using remote connections. Middle management, information system administration and general personnel

The organization owns the devices used for taking remote connections to organizations internal network. Middle management and general personnel

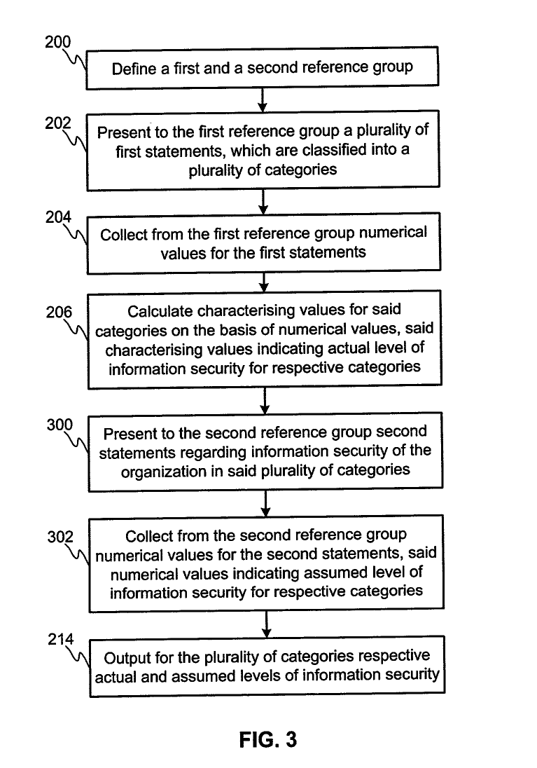

FIG. 3 is a flow chart illustrating another aspect of the invention. Similarly to the flow chart of FIG. 2 a first and a second reference group of people within the organization are defined, a plurality of first statements are presented to the first reference group, numerical values for these first statements are collected from the first reference group, and characterising values are calculated for said categories in steps 200, 202, 204 and 206. Then in steps 300 and 302, second statements regarding information security of the organization in said plurality of categories are presented to members of said second reference group, and numerical values for the second statements are collected from the second reference group. These numerical values readily indicate assumed level of information security for said categories. As a result, respective actual and assumed levels of information security are output for the plurality of categories in step 214.

That is, in this option, the second reference group gives preferably only one value for each category, the value giving their assumption of the level of information security of the organization in respective category. Like above, the second reference group expresses its assumption of the level of information security, but now the different aspects are not specified on as fine-grained level as above.

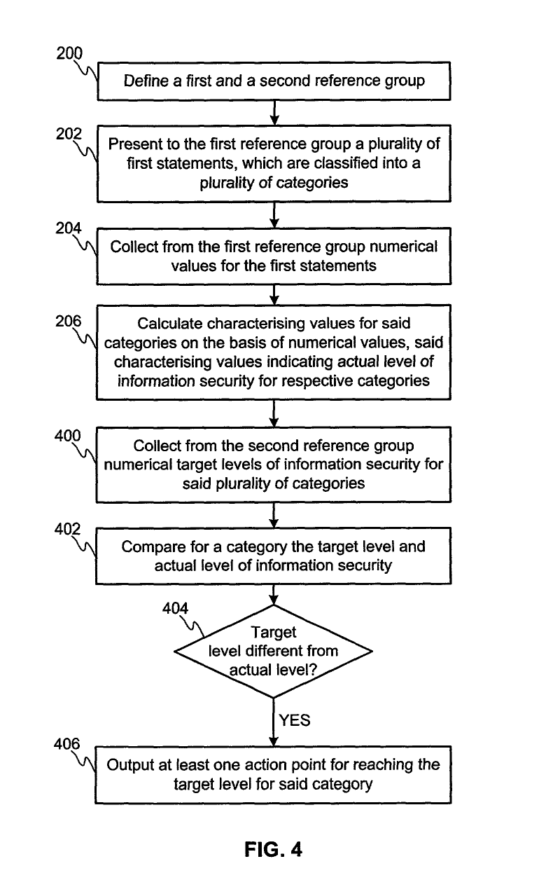

FIG. 4 is a flow chart illustrating still another aspect of the invention. Similarly to the flow chart of FIG. 2 a first and a second reference group of people within the organization are defined, a plurality of first statements are presented to the first reference group, numerical values for these first statements are collected from the first reference group, and characterising values are calculated for said categories in steps 200, 202, 204 and 206. In step 400, numerical target levels of information security for said plurality of categories are collected from the second reference group.

Then, the target level and actual level of information security are compared for different categories in step 402, and if it is found in step 404 that the actual level is different from the target level, at least one action point for reaching the target level for respective category is output in step 406.

Now, the assumed level of information security is not analysed, but the analysis concentrates on helping in development of information security. The second reference group states target values for different categories on the basis of analysed actual level of information security. By first analysing the actual level of information security, it is possible to define realistic target values and additionally to focus resources on areas where there are most severe defects in information security.

As mentioned above, target level of information security may be defined on the basis of analysed actual level of information security in order to develop information security of a given organization. Analysis of assumed level of information security is not needed for defining target level, but also assumed level may be used in defining the target. For this purpose, numerical target levels of information security for different categories are collected from the second reference group.

In order to find out how to reach the target, the target levels and actual levels are compared for each category. If the levels are different, at least one action point for reaching the target level for said category is output. The action points are based on previously identified and tested best practices and relate to verbal counterpart of the value given as a target. Additionally the action point depends on the actual level of information security.

For finding out if the target has been reached or not, an information security audit is set up. This means that the analysis of actual level of information security by means of the first reference group is repeated after a suitable period of time has lapsed since the last analysis. Suitable time period is completely up to the organization whose information security is analysed, but it may be for example 6 to 12 months.

The target levels and new actual levels of information security can then be compared. The (possible) differences between them can be classified into critical and less critical differences, critical difference indicating that the actual level of information security is substantially lower than the target. Less critical differences may be further allocated into moderate or low defects. By means of this kind of analysis, the areas where development of information security has failed and immediate actions are needed are clearly identifiable.

Above described information security audits are preferably repeated regularly in order to follow development of information security and to guide the development to the right direction on the basis of most recent information. In this way also possible defects in information security are identified as soon as possible. Additionally, since the organization itself defines the target levels for different categories, the development of information security and weighting of different aspects of information security are completely configurable for the needs of a given organization. Moreover, changing operating environments and requirements can be taken into account by adjusting the target levels when needed.

The invention further provides possibility to use either internal or external benchmarking for comparing an organization to other (possibly substantially similar) organizations or for comparing a unit of a given organization to different units of the organization. Since the level of information security can be stored in numerical format, it is straightforward to store results of analyses for future purposes. For example a block chart can then be generated for visualising differences between information security levels of different units of an organization or information security level of a given organization versus industry average.

To summarize, the method of the invention may be adjusted to give as an output a profile of actual level of information security, a profile of target level of information security, action points for reaching target level of security, internal benchmarking data, external benchmarking data, a profile indicating development of information security (results of consecutive audits), or a suitable combination of these.

The quantitative analysis of the invention may be further affirmed by means of qualitative interview analysis, which is made by a consultant, and wherein further meaning of various answers can be discussed. The results of this qualitative analysis can be attached to the quantitative analysis for example in form of a third reference group. Alternatively, the qualitative analysis may be used for adjusting the values given to different statements, whereby the overall result of the analysis is adjusted.

Certain aspects of the invention may be implemented by means of suitable combination of software and hardware. A suitable combination is for example a programmed computer, comprising a memory having at least one region for storing executable program code and a processor for executing the program code stored in the memory, wherein the program code comprises program code for executing the steps needed for analysing data according to the invention.

It is clear to a man skilled in the art that the embodiments and different aspects of the invention described above are given as examples only, while the features described in one example may be combined with features of another example and various modifications can be made within the scope and spirit of the invention as defined in the appended claims.

1. A method of analysing level of information security in an organization, said method comprising
defining a first and a second reference group of people within the organization, the first reference group comprising personnel, who are implementing strategic decisions of the organization, and the second reference group comprising personnel, who are participating in strategic decision-making,
presenting to members of said first reference group a plurality of first statements regarding information security of the organization, said first statements being classified into a plurality of categories,
collecting from the members of said first reference group numerical values for the first statements,
calculating characterising values for said categories on the basis of numerical values given to the first statements of respective categories, said characterising values indicating actual level of information security for said respective categories,
presenting to members of said second reference group said plurality of first statements regarding information security of the organization,
collecting from the members of said second reference group numerical values for the first statements,
calculating second characterising values for said categories on the basis of numerical values given by the second reference group to the first statements of respective categories, said second characterising values indicating assumed level of information security for said respective categories, and
outputting for the plurality of categories respective actual and assumed levels of information security.

2. A method as claimed in claim 1, wherein said characterising values are calculated by calculating mean, weighted mean or standard deviation of said numerical values.

3. A method as claimed in claim 1 further comprising
collecting from the second reference group numerical target levels of information security for said plurality of categories,
repeating the steps of presenting first statements to the first reference group, collecting numerical values for the first statements from the first reference group, and calculating characterising values for said plurality of categories after a predefined time period has lapsed, said repeating constituting an information security audit and resulting in new values for actual level of information security for said categories, and
outputting for the plurality of categories respective target levels and new actual levels of information security.

4. A method as claimed in claim 3 further comprising
comparing for a category the target level and new actual level of information security,
classifying differences between the target levels and new actual levels for categories into critical and less critical differences, and
outputting at least critical differences and an associated action point for suppressing respective critical difference.

5. A method as claimed in claim 1 further comprising
collecting from the second reference group numerical target levels of information security for said plurality of categories,
comparing for a category the target level and actual level of information security,
if the actual level is different from the target level, outputting at least one action point for reaching the target level for said category,
repeating the steps of presenting first statements to the first reference group, collecting numerical values for the first statements from the first reference group, and calculating characterising values for said plurality of categories after a predefined time period has lapsed, said repeating constituting an information security audit and resulting in new values for actual level of information security for said categories, and
outputting for the plurality of categories respective target levels and new actual levels of information security.

6. A method as claimed in claim 3 further comprising
repeating the step of collecting target values after said audit, and
repeating said audit after a predefined time period has lapsed.

7. A method as claimed in claim 1, wherein the first reference group comprises subgroups of information system administration, middle management and specialists, general personnel, and/or production personnel, and at least partially different first statements are selectively presented to different subgroups, and
the second reference group comprises top management and owners of processes.

8. A method as claimed in claim 1, wherein said categories are data security, administrative and organizational information security, personnel security, physical security, telecommunication security, software security, facilities security, operations security, contingency planning, and compliance with requirements.

9. A method as claimed in claim 1 further comprising
storing actual levels of information security of different organizations in said plurality of categories, and
outputting actual levels of information security of said different organizations in said plurality of categories.

10. A method as claimed in claim 1 further comprising
storing actual levels of information security of different units of an organization in said plurality of categories, and
outputting actual levels of information security of said different units of the organization in said plurality of categories.

11. A method as claimed in claim 1 further comprising
verifying the actual levels of information security in said plurality of categories by means of qualitative interview analysis.

12. A method of analysing level of information security in an organization, said method comprising
defining a first and a second reference group of people within the organization, the first reference group comprising personnel, who are implementing strategic decisions of the organization, and the second reference group comprising personnel, who are participating in strategic decision-making,
presenting to members of said first reference group a plurality of first statements regarding information security of the organization, said first statements being classified into a plurality of categories,
collecting from the members of said first reference group numerical values for the first statements,
calculating characterising values for said categories on the basis of numerical values given to the first statements of respective categories, said characterising values indicating actual level of information security for said respective categories,
presenting to members of said second reference group second statements regarding information security of the organization in said plurality of categories,
collecting from the members of said second reference group numerical values for the second statements, said numerical values indicating assumed level of information security for said categories, and
outputting for the plurality of categories respective actual and assumed levels of information security.

13. A method of analysing level of information security in an organization, said method comprising
defining a first and a second reference group of people within the organization, the first reference group comprising personnel, who are implementing strategic decisions of the organization, and the second reference group comprising personnel, who are participating in strategic decision-making,
presenting to members of said first reference group a plurality of first statements regarding information security of the organization, said first statements being classified into a plurality of categories,
collecting from the members of said first reference group numerical values for the first statements,
calculating characterising values for said categories on the basis of numerical values given to the first statements of respective categories, said characterising values indicating actual level of information security for said respective categories,
collecting from the second reference group numerical target levels of information security for said plurality of categories,
comparing for a category the target level and actual level of information security, and if the actual level is different from the target level, outputting at least one action point for reaching the target level for said category.

14. A method as claimed in claim 13 further comprising
repeating the steps of presenting first statements to the first reference group, collecting numerical values for the first statements from the first reference group, and calculating characterising values for said plurality of categories after a predefined time period has lapsed, said repeating constituting an information security audit and resulting in new values for actual level of information security for said categories, and
outputting for the plurality of categories respective target levels and new actual levels of information security.

15. A computer program product comprising computer program code which, when executed in a computer device, provides analysing level of information security of an organization comprising
receiving numerical values for a plurality of first statements regarding information security of the organization, said first statements being classified into a plurality of categories and said numerical values being given by a first reference group within the organization, the first reference group comprising personnel, who are implementing strategic decisions of the organization,
calculating characterising values for said categories on the basis of numerical values received for the first statements of respective categories, said characterising values indicating actual level of information security for said respective categories,
receiving second numerical values for said plurality of first statements regarding information security of the organization, said second numerical values being given by a second reference group within the organization, the second reference group comprising personnel, who are participating in strategic decision-making,
calculating second characterising values for said categories on the basis of second numerical values received for the first statements of respective categories, said second characterising values indicating assumed level of information security for said respective categories, and
outputting for the plurality of categories respective actual and assumed levels of information security.

16. A computer program product as claimed in claim 15, wherein said characterising values are calculated by calculating mean, weighted mean or standard deviation of said numerical values.

17. A computer program product as claimed in claim 15 further providing
receiving numerical target levels of information security for said plurality of categories, the target levels being given by the second reference group,
receiving new numerical values for said plurality of first statements said new numerical values being given by a first reference group within the organization,
calculating new characterising values for said categories on the basis of new numerical values received for the first statements of respective categories, said new characterising values indicating new actual levels of information security for said categories, and
outputting for the plurality of categories respective target levels and new actual levels of information security.

18. A computer program product as claimed in claim 17 further providing
comparing for a category the target level and new actual level of information security, and
classifying differences between the target levels and new actual levels for categories into critical and less critical differences, and
outputting at least critical differences and an associated action point for suppressing respective critical difference.

19. A computer program product as claimed in claim 15 further providing
receiving numerical target levels of information security for said plurality of categories, the target levels being given by the second reference group,
comparing for a category the target level and actual level of information security,
if the actual level is different from the target level, outputting at least one action point for reaching the target level for said category,
receiving new numerical values for said plurality of first statements said new numerical values being given by a first reference group within the organization,
calculating new characterising values for said categories on the basis of new numerical values received for the first statements of respective categories, said new characterising values indicating new actual levels of information security for said categories, and
outputting for the plurality of categories respective target levels and new actual levels of information security.

20. A computer program product as claimed in claim 15, wherein the first reference group comprises subgroups of information system administration, middle management and specialists, general personnel, and/or production personnel, and at least partially different first statements are selectively presented to different subgroups, and
the second reference group comprises top management and owners of processes.

21. A computer program product as claimed in claim 15, wherein said categories are data security, administrative and organizational information security, personnel security, physical security, telecommunication security, software security, facilities security, operations security, contingency planning, and compliance with requirements.

22. A computer program product as claimed in claim 15 further providing
storing actual levels of information security of different organizations in said plurality of categories, and
outputting actual levels of information security of said different organizations in said plurality of categories.

23. A computer program product as claimed in claim 15 further providing
storing actual levels of information security of different units of an organization in said plurality of categories, and
outputting actual levels of information security of said different units of the organization in said plurality of categories.

24. A computer program product comprising computer program code which, when executed in a computer device, provides analysing level of information security of an organization comprising
receiving numerical values for a plurality of first statements regarding information security of the organization, said first statements being classified into a plurality of categories and said numerical values being given by a first reference group within the organization, the first reference group comprising personnel, who are implementing strategic decisions of the organization,
calculating characterising values for said categories on the basis of numerical values received for the first statements of respective categories, said characterising values indicating actual level of information security for said respective categories,
receiving numerical values for a plurality of second statements regarding information security of the organization in said plurality of categories, said numerical values being given by a second reference group within the organization, the second reference group comprising personnel, who are participating in strategic decision-making, and said numerical values indicating assumed level of information security for said categories, and
outputting for the plurality of categories respective actual and assumed levels of information security.

25. A computer program product comprising computer program code which, when executed in a computer device, provides analysing level of information security of an organization comprising
receiving numerical values for a plurality of first statements regarding information security of the organization, said first statements being classified into a plurality of categories and said numerical values being given by a first reference group within the organization, the first reference group comprising personnel, who are implementing strategic decisions of the organization,
calculating characterising values for said categories on the basis of numerical values received for the first statements of respective categories, said characterising values indicating actual level of information security for said respective categories,
receiving numerical target levels of information security for said plurality of categories, said numerical target levels being given by a second reference group within the organization, the second reference group comprising personnel, who are participating in strategic decision-making, and
comparing for a category the target level and actual level of information security, and if the actual level is different from the target level, outputting at least one action point for reaching the target level for said category.

26. A computer program product as claimed in claim 25 further providing
receiving new numerical values for said plurality of first statements said new numerical values being given by a first reference group within the organization,
calculating new characterising values for said categories on the basis of new numerical values received for the first statements of respective categories, said new characterising values indicating new actual level of information security for said respective categories, and
outputting for the plurality of categories respective target levels and new actual levels of information security.

27. A data processing system for analysing level of information security of an organization, comprising
a programmed computer, further comprising
a memory having at least one region for storing executable program code, and
a processor for executing the program code stored in the memory, wherein the program code, further comprising
program code for receiving numerical values for a plurality of first statements regarding information security of the organization, said first statements being classified into a plurality of categories and said numerical values being given by a first reference group within the organization, the first reference group comprising personnel, who are implementing strategic decisions of the organization,
program code for calculating characterising values for said categories on the basis of numerical values received for the first statements of respective categories, said characterising values indicating actual level of information security for said respective categories,
program code for receiving second numerical values for said plurality of first statements regarding information security of the organization, said second numerical values being given by a second reference group within the organization, the second reference group comprising personnel, who are participating in strategic decision-making,
program code for calculating second characterising values for said categories on the basis of second numerical values received for the first statements of respective categories, said second characterising values indicating assumed level of information security for said respective categories, and
program code for outputting for the plurality of categories respective actual and assumed levels of information security.

28. A data processing system as claimed in claim 27, wherein said program code for calculating characterising values is adapted to calculate the characterising values by calculating mean, weighted mean or standard deviation of said numerical values.

29. A data processing system as claimed in claim 27 further comprising
program code for receiving numerical target levels of information security for said plurality of categories, the target levels being given by the second reference group,
program code for receiving new numerical values for said plurality of first statements said new numerical values being given by a first reference group within the organization,
program code for calculating new characterising values for said categories on the basis of new numerical values received for the first statements of respective categories, said new characterising values indicating new actual levels of information security for said categories, and
program code for outputting for the plurality of categories respective target levels and new actual levels of information security.

30. A data processing system as claimed in claim 29 further comprising
program code for comparing for a category the target level and new actual level of information security,
program code for classifying differences between the target levels and new actual levels for categories into critical and less critical differences, and
program code for outputting at least critical differences and an associated action point for suppressing respective critical difference.

31. A data processing system as claimed in claim 27 further comprising
program code for receiving numerical target levels of information security for said plurality of categories, the target levels being given by the second reference group,
program code for comparing for a category the target level and actual level of information security,
program code for outputting at least one action point for reaching the target level for said category, if the actual level is different from the target level,
program code for receiving new numerical values for said plurality of first statements said new numerical values being given by a first reference group within the organization,
program code for calculating new characterising values for said categories on the basis of new numerical values received for the first statements of respective categories, said new characterising values indicating new actual levels of information security for said categories, and
program code for outputting for the plurality of categories respective target levels and new actual levels of information security.

32. A data processing system as claimed in claim 27, wherein the first reference group comprises subgroups of information system administration, middle management and specialists, general personnel, and/or production personnel, and at least partially different first statements are selectively presented to different subgroups, and
the second reference group comprises top management and owners of processes.

33. A data processing system as claimed in claim 27, wherein said categories are data security, administrative and organizational information security, personnel security, physical security, telecommunication security, software security, facilities security, operations security, contingency planning, and compliance with requirements.

34. A data processing system as claimed in claim 27 further comprising
program code for storing actual levels of information security of different organizations in said plurality of categories, and
program code for outputting actual levels of information security of said different organizations in said plurality of categories.

35. A data processing system as claimed in claim 27 further comprising
program code for storing actual levels of information security of different units of an organization in said plurality of categories, and
program code for outputting actual levels of information security of said different units of the organization in said plurality of categories.

36. A data processing system for analysing level of information security of an organization, comprising
a programmed computer, further comprising
a memory having at least one region for storing executable program code, and
a processor for executing the program code stored in the memory, wherein the program code, further comprising
program code for receiving numerical values for a plurality of first statements regarding information security of the organization, said first statements being classified into a plurality of categories and said numerical values being given by a first reference group within the organization, the first reference group comprising personnel, who are implementing strategic decisions of the organization,
program code for calculating characterising values for said categories on the basis of numerical values received for the first statements of respective categories, said characterising values indicating actual level of information security for said respective categories,
program code for receiving numerical values for a plurality of second statements regarding information security of the organization in said plurality of categories, said numerical values being given by a second reference group within the organization, the second reference group comprising personnel, who are participating in strategic decision-making, and said numerical values indicating assumed level of information security for said categories, and
program code for outputting for the plurality of categories respective actual and assumed levels of information security.

37. A data processing system for analysing level of information security of an organization, comprising
a programmed computer, further comprising
a memory having at least one region for storing executable program code, and
a processor for executing the program code stored in the memory, wherein the program code, further comprising
program code for receiving numerical values for a plurality of first statements regarding information security of the organization, said first statements being classified into a plurality of categories and said numerical values being given by a first reference group within the organization, the first reference group comprising personnel, who are implementing strategic decisions of the organization,
program code for calculating characterising values for said categories on the basis of numerical values received for the first statements of respective categories, said characterising values indicating actual level of information security for said respective categories,
program code for receiving numerical target levels of information security for said plurality of categories, said numerical target levels being given by a second reference group within the organization, the second reference group comprising personnel, who are participating in strategic decision-making, and
program code for comparing for a category the target level and actual level of information security, and if the actual level is different from the target level, outputting at least one action point for reaching the target level for said category.

38. A data processing system as claimed in claim 37 further comprising
program code for receiving new numerical values for said plurality of first statements said new numerical values being given by a first reference group within the organization,
program code for calculating new characterising values for said categories on the basis of new numerical values received for the first statements of respective categories, said new characterising values indicating new actual level of information security for said respective categories, and
program code for outputting for the plurality of categories respective target levels and new actual levels of information security.
